(19) United States
(12) Patent Application Publication
(10) Pub. No.: US 2015/0039535 A1
(43) Pub. Date: Feb. 5, 2015

(54) GRASPING A BIAS OF INFORMATION FROM AN INTERNET MEDIUM FOR SUPPORTING A SURVEY

(71) Applicant: INTERNATIONAL BUSINESS MACHINES CORPORATION, ARMONK, NY (US)

(72) Inventors: Emiko Takeuchi, Tokyo (JP); Daisuke Takuma, Tokyo (JP); Hirobumi Toyoshima, Tokyo (JP)

(21) Appl. No.: 14/336,750

(22) Filed: Jul. 21, 2014

(30) Foreign Application Priority Data
Jul. 31, 2013 (JP) 2013-159838

(51) Int. Cl. G06N 5/04

(52) U.S. Cl. CPC G06N 5/04
USPC 706/1

(57) ABSTRACT

In one embodiment of the present invention, an apparatus may be used for supporting a survey based on information in an Internet medium. The apparatus comprises: a first acquisition hardware unit, wherein the first acquisition hardware unit acquires first evaluation information representing a degree of evaluation acquired by a survey of a real society pertaining to a prescribed target; a second acquisition hardware unit, wherein the second acquisition hardware unit acquires second evaluation information representing a degree of evaluation in the Internet medium pertaining to the prescribed target; and an estimator hardware unit, wherein the estimator hardware unit estimates a bias in information in the Internet medium based on a deviation of the second evaluation information from the first evaluation information.

The present invention relates to an apparatus and a method for supporting a survey. In particular, the present invention relates to an apparatus and a method for supporting a survey based on information in an Internet medium.

Recently, Internet media, such as SNSs (social networking services), electronic bulletin boards, microblogs, and video sites, have been widespread. Accordingly, statistical surveys (surveys of public opinion etc.) based on information in Internet media have been attracting attention.

Techniques pertaining to use of statistical surveys through computers or results of the statistical surveys have also been known as techniques described in official gazettes.

Known prior art discloses a questionnaire compilation system that measures times required for answers by answerers answering each question pattern, acquires a representative value of the times required for answers by the answerer answering each question pattern, acquires an answer time index for the answered question pattern for each answerer by dividing the time required for an answer by the representative value, acquires an average value by dividing the sum of the answer time indices by the number of the answered question patterns, and omits answers of a prescribed ratio in an ascending order of the average value, thereby compiling a questionnaire.

Known prior art discloses an information processing apparatus in which an item evaluation acquisition unit acquires evaluation values assigned by each user to respective items, a user statistical value calculator calculates a user statistical value that indicates a tendency of evaluation by a target user, using at least one of the number of items evaluated by the target user, evaluation values assigned by the target user to each item, the number of evaluations provided by each user concerning the item evaluated by the target user, and an evaluation value provided by each user concerning the item evaluated by the target user, and an information presenting unit controls presentation of information pertaining to the item to the target user on the basis of the user statistical value.

Known prior art discloses an information providing system in which evaluation value calculation means calculates a deviation of statistical information in multiple information categories for classifying the statistical information and calculates first evaluation values of statistical targets for the respective information categories using the deviation, user premium control means provides a user terminal with a function for setting priorities corresponding to the respective information categories and receives priority setting information transmitted from the user terminal, and statistical target extraction control means calculates second evaluation values of the statistical targets for the respective information categories using the first evaluation value and the priority setting information and extracts a statistical target suitable for a user through use of the second evaluation values.

Known prior art discloses a store management system including: a management DB that is in a DB server and stores the previous, actual numbers of customers; and a management server that derives a prediction value of the number of customers on a prediction target date using the actual numbers of customers in multiple previous time periods stored in the management DB.

Known prior art discloses a risk diagnosis system that preliminarily stores reference risk map data pertaining to a risk occurrence frequency and the magnitude of damage, reads the reference risk map data on a diagnosis target company, and corrects this data using data in consideration of answer information read from an answer information storing medium to generate company-specific risk map data.

In a statistical survey based on the information in the Internet medium described above, a bias in a result of the statistical survey due to deviation of a user segment of the Internet medium causes a problem. Conventionally, a mechanism that calculates such a bias and analyzes a gap between the statistical information in the Internet medium and real statistical information has not been provided.

Note that all the techniques in the known prior art are techniques of usages of statistical surveys or results of the statistical surveys through computers, but provide no solution to such a problem.

It is an object of the present invention to grasp a bias in information in an Internet medium and then allow a survey based on the information to be performed.

### SUMMARY

In one embodiment of the present invention, an apparatus may be used for supporting a survey based on information in an Internet medium. The apparatus comprises: a first acquisition hardware unit, wherein the first acquisition hardware unit acquires first evaluation information representing a degree of evaluation acquired by a survey of a real society pertaining to a prescribed target; a second acquisition hardware unit, wherein the second acquisition hardware unit acquires second evaluation information representing a degree of evaluation in the Internet medium pertaining to the prescribed target; and an estimator hardware unit, wherein the estimator hardware unit estimates a bias in information in the Internet medium based on a deviation of the second evaluation information from the first evaluation information.

In another embodiment of the present invention, an apparatus may be used for supporting a survey based on information in an Internet medium. The apparatus comprises: a first acquisition hardware unit, wherein the first acquisition hardware unit acquires, for each policy among a plurality of policies belonging to any of a plurality of categories predefined according to a policy of a target of the survey, a first evaluation value representing a degree of affirmative evaluation acquired by a survey in a real society pertaining to each of the policies; a second acquisition hardware unit, wherein the second acquisition hardware unit acquires, for each policy among the plurality of policies, a second evaluation value representing a degree of affirmative evaluation in the Internet medium pertaining to each of the policies; an estimator hardware unit, wherein the estimator hardware unit estimates a bias in information in the Internet medium by averaging, across the policies, a degree of a deviation of the second evaluation value from the first evaluation value on each policy among the policies; a third acquisition hardware unit, wherein the third acquisition hardware unit acquires a third evaluation value representing a degree of affirmative evaluation in the Internet medium pertaining to the policy of the target of the survey; and a predictor hardware unit, wherein the predictor hardware unit predicts a degree of actual affirmative evaluation pertaining to the policy of the target of the survey by correcting the third evaluation value based on the bias.

In another embodiment of the present invention, an apparatus may be used for supporting a survey based on information in an Internet medium. The apparatus comprises: a first acquisition hardware unit, wherein the first acquisition hardware unit acquires, for each policy among a plurality of policies belonging to any of a plurality of categories predefined according to a policy of a target of the survey, a first evaluation value representing a degree of affirmative evaluation acquired by a survey in a real society pertaining to each of the policies; a second acquisition hardware unit, wherein the second acquisition hardware unit acquires, for each policy among the plurality of policies, a second evaluation value representing a degree of affirmative evaluation in the Internet medium pertaining to each of the policies; an estimator hardware unit, wherein the estimator hardware unit estimates a regression expression having, as a regression coefficient, a bias in information in the Internet medium, by performing regression while adopting, as an objective variable, a degree of a deviation of the second evaluation value from the first evaluation value on each policy among the policies and adopting, as an explanatory variable, information representing whether each of the policies belongs to each of the categories or not; a third acquisition hardware unit, wherein the third acquisition hardware unit acquires a third evaluation value representing a degree of affirmative evaluation in the Internet medium pertaining to the policy of the target of the survey; and a predictor hardware unit, wherein the predictor hardware unit predicts a degree of actual affirmative evaluation pertaining to the policy of the target of the survey by setting the third evaluation value as the second evaluation value in the objective variable of the regression expression.

### BRIEF DESCRIPTION OF THE SEVERAL VIEWS OF THE DRAWINGS

FIG. 1 is a diagram showing an example of a hardware configuration of a computer to which an embodiment of the present invention is applicable;

FIG. 2 is a block diagram showing an example of a functional configuration of a statistical information analysis apparatus in the embodiment of the present invention;

FIG. 3 is a flowchart showing a first operation example of the statistical information analysis apparatus of the embodiment of the present invention;

FIGS. 4a and 4b is a diagram showing an example of information stored in a real-related statistical value storage according to the first operation example of the statistical information analysis apparatus of the embodiment of the present invention;

FIGS. 5a and 5b is a diagram showing an example of information stored in an SNS-related statistical value storage according to the first operation example of the statistical information analysis apparatus of the embodiment of the present invention;

FIG. 6 is a diagram showing an example of information stored in a bias storage according to the first operation example of the statistical information analysis apparatus of the embodiment of the present invention;

FIG. 7 is a flowchart showing a second operation example of the statistical information analysis apparatus of the embodiment of the present invention;

FIGS. 8a, 8b and 8c is a diagram showing an example of information stored in the real-related statistical value storage according to the second operation example of the statistical information analysis apparatus of the embodiment of the present invention;

FIGS. 9a, 9b, and 9c is an example of information stored in the SNS-related statistical value storage according to the second operation example of the statistical information analysis apparatus of the embodiment of the present invention; and

FIG. 10 is an example of information stored in the bias storage according to the second operation example of the statistical information analysis apparatus of the embodiment of the present invention.

### DETAILED DESCRIPTION

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Referring to the accompanying drawings, an embodiment of the present invention is hereinafter described in detail. This embodiment provides a statistical information analysis apparatus that analyzes a gap between statistical information in an Internet medium and real statistical information. Note that the Internet medium is typified by an SNS and described. However, this description does not intend to omit Internet media (e.g., electronic bulletin boards, microblogs, video sites, etc.) other than SNSs.

### Hardware Configuration of Statistical Information Analysis Apparatus

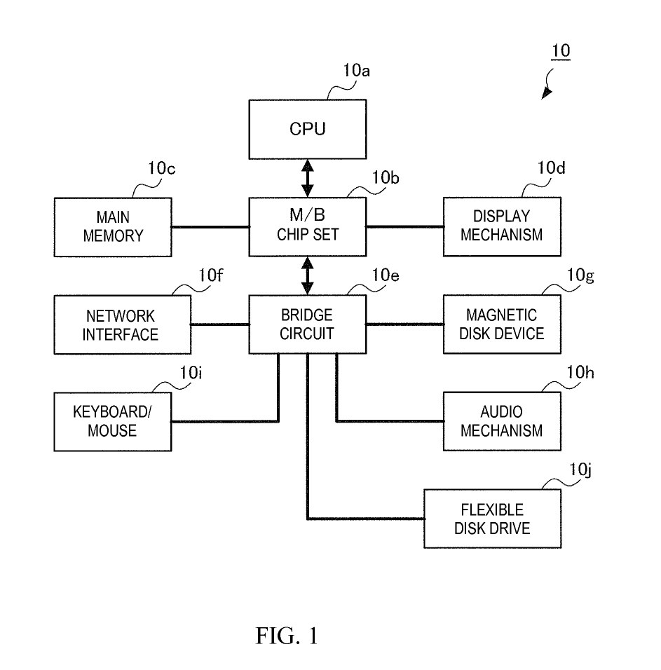

FIG. 1 is a diagram showing an example of a hardware configuration of a statistical information analysis apparatus 10 in this embodiment. As shown in this diagram, the statistical information analysis apparatus 10 includes: a CPU (central processing unit) 10a as operation means; a main memory 10c connected to the CPU 10a via a M/B (motherboard) chip set 10b; and a display mechanism 10d connected to the CPU 10a via the M/B chip set 10b in the same manner. A network interface 10f, a magnetic disk device (HDD) 10g, an audio mechanism 10h, a keyboard/mouse 10i, and a flexible disk drive 10j are connected to the M/B chip set 10b via a bridge circuit 10e.

In FIG. 1, the configurational elements are connected to each other via a bus. For instance, the CPU 10a and the M/B chip set 10b are connected to each other, and the M/B chip set 10b and the main memory 10c are connected to each other, via a CPU bus. The M/B chip set 10b and the display mechanism 10d may be connected to each other via an AGP (accelerated graphics port). In the case where the display mechanism 10d includes a video card supporting PCI Express, the M/B chip set 10b and this video card are connected to each other via a PCI Express (PCIe) bus. In the case of connection to the bridge circuit 10e, the network interface 10f may be, for instance, PCI Express. The magnetic disk device 10g may adopt, for instance, serial ATA (AT attachment), parallel transfer ATA, or PCI (peripheral components interconnect). Furthermore, the keyboard/mouse 10i and the flexible disk drive 10j may adopt USB (universal serial bus).

### Functional Configuration of Statistical Information Analysis Apparatus

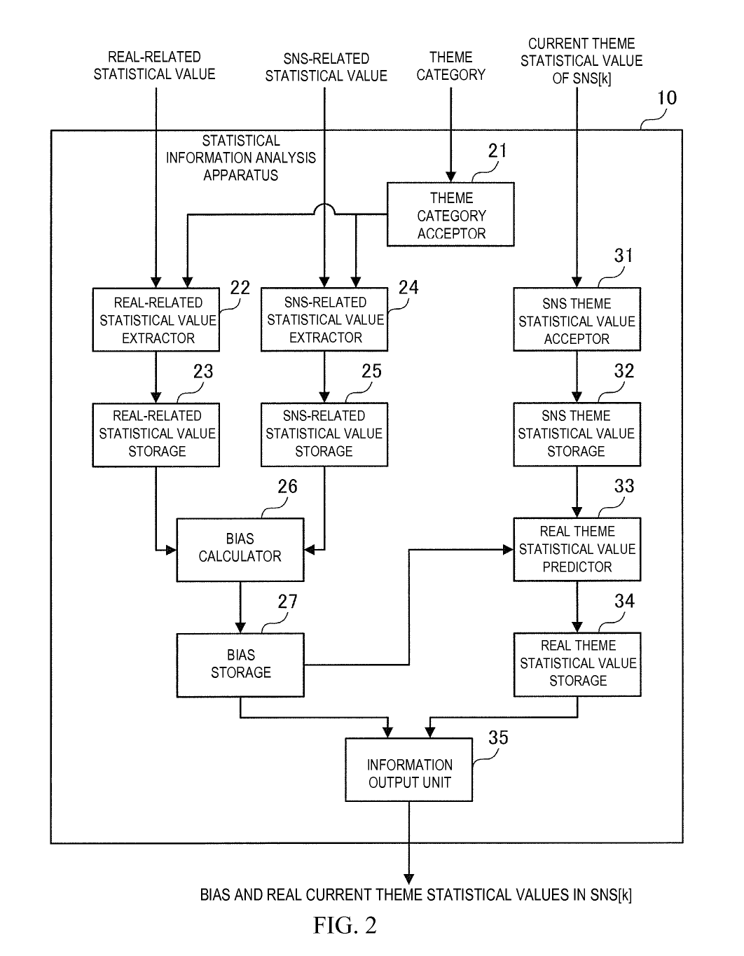

FIG. 2 is a block diagram showing an example of a functional configuration of the statistical information analysis apparatus 10 in this embodiment. As shown in this diagram, the statistical information analysis apparatus 10 includes a theme category acceptor 21, a real-related statistical value extractor 22, a real-related statistical value storage 23, an SNS-related statistical value extractor 24, an SNS-related statistical value storage 25, a bias calculator 26, and a bias storage 27. This apparatus further includes an SNS theme statistical value acceptor 31, an SNS theme statistical value storage 32, a real theme statistical value predictor 33, a real theme statistical value storage 34, and an information output unit 35.

The theme category acceptor 21 accepts a category of a statistical theme (hereinafter, referred to a “theme category”). The statistical theme is a theme to be surveyed by taking statistics. For instance, evaluation on a certain target (a ratio of approval to opposition in the case where the target is a policy, a ratio of good to bad in the case where the target is a product, etc.) corresponds thereto. The theme category is preset as a category to which a statistical theme belongs. If the target is a policy, the theme category is an organization proposing the policy or a case to which the policy is related (“child” in the case where the policy is a child-related policy, “energy” in the case where the policy is an energy-related policy, etc.). Here, a ratio of approval to opposition with respect to a certain policy is exemplified as a statistical theme. An organization P proposing the policy, and a case Q to which the policy is related are accepted as theme categories. A method of setting a theme category may be a method of manually setting on each statistical theme, a method of using tags assigned to news articles and the like, a method of setting according to words or phrases in titles or descriptions of statistics and the like.

The real-related statistical value extractor 22 extracts a statistical value related to a theme category accepted by the theme category acceptor 21 from among real, previous statistical values. Here, the real, previous statistical values are statistical values acquired by a survey (a survey of public opinion etc.) in a real society, and include, for instance, an approval rate for the Cabinet in 20XX, an approval rate for increase of consumption tax, etc. Since theme categories are assigned to the real, previous statistical values, a statistical value related to a theme category can be extracted. Note that, hereinafter, the extracted statistical value is referred to as a “real-related statistical value”, and a real-related statistical value related to a theme category C is represented as X_{Ci} (i=1, 2, . . . , m_{c}). In this embodiment, a real-related statistical value is used as an example of first evaluation information that represents a degree of evaluation acquired by a survey in a real society related to a prescribed target, and an example of a first evaluation value that is a value representing a degree of affirmative evaluation related to each policy. The real-related statistical value extractor 22 is provided as an example of a first acquisition unit that acquires first evaluation information or a first evaluation value.

The real-related statistical value storage 23 stores a real-related statistical value X_{Ci} extracted by the real-related statistical value extractor 22.

The SNS-related statistical value extractor 24 extracts a statistical value related to the theme category accepted by the theme category acceptor 21 from among previous statistical values of an SNS[k]. Here, the SNS[k] is the k-th SNS among multiple SNSs (k=1, 2, . . . , K). The previous statistical values of the SNS[k] are statistical values having been already known from information on the SNS[k], and may be, for instance, statistical values acquired through questionnaire of the SNS[k], statistical values based on the number of representational items, such as approval or opposition, extracted by means of patterns, such as words and phrases, from content written in the SNS[k], etc. Here, a bias due to masquerade or the like may be removed from the statistical values. Since theme categories are also assigned to the previous statistical values of the SNS[k], a statistical value related to a theme category can be extracted. Note that, hereinafter, the extracted statistical value is referred to as an “SNS-related statistical value”, and an SNS-related statistical value that has been extracted from the previous statistical values of the SNS[k] and is related to the theme category C is represented as Y_{kCi}=1, 2, . . . , m_{c}). In this embodiment, the SNS-related statistical value is used as an example of second evaluation information that represents a degree of evaluation in an Internet medium related to a prescribed target, and an example of a second evaluation value that is a value representing a degree of affirmative evaluation in an Internet medium related to each policy. The SNS-related statistical value extractor 24 is provided as an example of the second acquisition unit that acquires the second evaluation information or the second evaluation value.

The SNS-related statistical value storage 25 stores an SNS-related statistical value Y_{kCi} extracted by the SNS-related statistical value extractor 24.

The bias calculator 26 calculates a bias Bₖ in the SNS[k] on the basis of the real-related statistical value X_{Ci} stored in the real-related statistical value storage 23, and the SNS-related statistical value Y_{kCi} stored in the SNS-related statistical value storage 25. In this embodiment, the bias calculator 26 is provided as an example of an estimator that estimates a bias in information in the Internet medium.

The bias storage 27 stores the bias Bₖ in the SNS[k] calculated by the bias calculator 26.

The SNS theme statistical value acceptor 31 accepts a current theme statistical value Zₖ of the SNS[k]. The current theme is a statistical theme to be currently surveyed. The current theme statistical value is a statistical value of the theme. Here, the current theme is a specific policy related to the case Q proposed by the organization P. The approval rate for the specific policy acquired from information on the SNS[k] is acquired as the current theme statistical value Zₖ of the SNS[k]. Note that the current theme statistical value Zₖ of the SNS[k] may be a statistical value acquired by a method analogous to that of the previous statistical value of the SNS[k] described above. In this embodiment, the current theme statistical value of the SNS[k] is used as an example of third evaluation information that represents a degree of evaluation in the Internet medium related to another target, and an example of a third evaluation value that is a value representing a degree of affirmative evaluation in the Internet medium related to the policy that is the target of the survey. The SNS theme statistical value acceptor 31 is provided as an example of a third acquisition unit that acquires the third evaluation information or the third evaluation value.

The SNS theme statistical value storage 32 stores the current theme statistical value Zₖ of the SNS[k] accepted by the SNS theme statistical value acceptor 31.

The real theme statistical value predictor 33 performs correction by subtracting the bias Bₖ in the SNS[k] stored in the bias storage 27 from the current theme statistical value Zₖ of the SNS[k] stored in the SNS theme statistical value storage 32, thereby calculating a corrected theme statistical value of the SNS[k]. This predictor predicts a real, current theme statistical value by averaging the corrected theme statistical value of the SNS[k] across all the SNSs. In this embodiment, the real theme statistical value predictor 33 is provided as an example of a predictor that predicts actual evaluation related to another target, and an example of a predictor that predicts the degree of actual affirmative evaluation related to the policy that is the target of the survey.

The real theme statistical value storage 34 stores the real, current theme statistical value predicted by the real theme statistical value predictor 33.

The information output unit 35 outputs the bias Bₖ in the SNS[k] stored in the bias storage 27, and the real, current theme statistical value stored in the real theme statistical value storage 34. Here, the bias Bₖ in the SNS[k] may be output for each theme category.

These functional units can be achieved by software and hardware resources cooperating with each other. More specifically, the CPU 10a reads a program that achieves the theme category acceptor 21, the real-related statistical value extractor 22, the SNS-related statistical value extractor 24, the bias calculator 26, the SNS theme statistical value acceptor 31, the real theme statistical value predictor 33, and the information output unit 35, from, for instance, the magnetic disk device 10g onto the main memory 10c, and executes the program to achieve these functional units. The real-related statistical value storage 23, the SNS-related statistical value storage 25, the bias storage 27, the SNS theme statistical value storage 32, and the real theme statistical value storage 34 are achieved by, for instance, the magnetic disk device 10g.

### First Operation of Statistical Information Analysis Apparatus

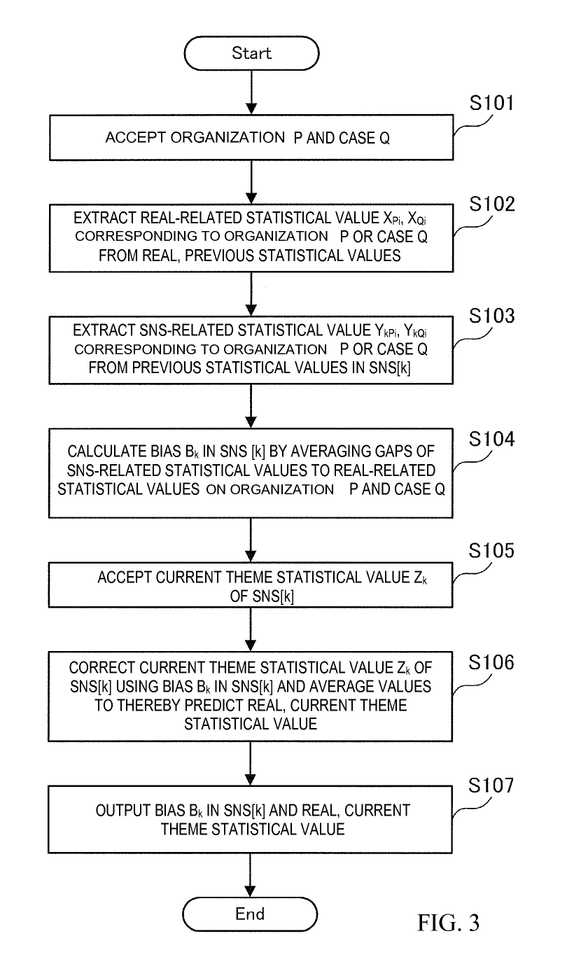

FIG. 3 is a flowchart showing a first operation example of the statistical information analysis apparatus 10. In the first operation example, the organization P and the case Q are provided as theme categories.

When the operation is started, the theme category acceptor 21 accepts the organization P and the case Q as theme categories (step 101). These theme categories are passed from the theme category acceptor 21 to the real-related statistical value extractor 22 and the SNS-related statistical value extractor 24.

Next, the real-related statistical value extractor 22 extracts a real-related statistical value X_{Pi} related to the organization P accepted in step 101, and a real-related statistical value X_{Qi} related to the case Q accepted in step 101, from the real, previous statistical values (step 102). For instance, this extractor 22 extracts an approval rate X_{P1} for a policy R of the organization P, an approval rate X_{P2} for a policy S of the organization P, and an approval rate X_{P3} for a policy T of the organization P, as the real-related statistical values X_{Pi}, and also extracts an approval rate X_{Q1} for the policy R related to the case Q, and an approval rate X_{Q2} for a policy U related to the case Q, as the real-related statistical values X_{Qi}. The real-related statistical value X_{Pi} and the real-related statistical value X_{Qi} are stored in the real-related statistical value storage 23.

The SNS-related statistical value extractor 24 extracts an SNS-related statistical value Y_{kPi} related to the organization P accepted in step 101 and an SNS-related statistical value Y₁ related to the case Q accepted in step 101, from the previous statistical values of the SNS[k] (step 103). For instance, the extractor 24 extracts an approval rate Y_{kP1} for the policy R of the organization P, an approval rate Y_{kP2} for the policy S of the organization P and an approval rate Y_{kP3} for the policy T of the organization P, as the SNS-related statistical values Y_{kPi}, and also extracts an approval rate Y_{kQ1} for the policy R related to the case Q and an approval rate Y_{kQ2} for the policy U related to the case Q, as SNS-related statistical values Y_{kQi}. The SNS-related statistical value Y_{kPi} and the SNS-related statistical value Y_{kQi} are stored in the SNS-related statistical value storage 25.

Thus, the real-related statistical values X_{Pi} and X_{Qi} are stored in the real-related statistical value storage 23, and the SNS-related statistical values Y_{kPi} and Y_{kQi} are stored in the SNS-related statistical value storage 25, and then the bias calculator 26 calculates the bias Bₖ in the SNS[k] on the basis of the real-related statistical values X_{Pi} and X_{Qi} and the SNS-related statistical values Y_{kPi} and Y_{kQi}. That is, this calculator calculates the bias Bₖ by averaging relative values of the SNS-related statistical values related to the respective theme categories with respect to the real-related statistical values, across all the theme categories (step 104). Here, the relative value of the SNS-related statistical value with respect to the real-related statistical value is a gap (deviation) between the SNS-related statistical value and the real-related statistical value, and may be a difference between the SNS-related statistical value and the real-related statistical value, a ratio of the SNS-related statistical value to the real-related statistical value, a difference that is between the SNS-related statistical value and the real-related statistical value and normalized by the real-related statistical value, or the like. For instance, the simplest method of calculating a bias is a method of averaging a ratio of the SNS-related statistical value to the real-related statistical value for each theme category, and represented by the following expression.

$${B}_{k} = \frac{{\sum }_{i = 1}^{3} \frac{{Y}_{kPi}}{{X}_{Pi}} + {\sum }_{i = 1}^{2} \frac{{Y}_{kQi}}{{X}_{Qi}}}{5} \qquad Expression 1$$

This bias Bₖ is stored in the bias storage 27.

Meanwhile, the SNS theme statistical value acceptor 31 accepts the current theme statistical value Zₖ of the SNS[k] (step 105). The current theme statistical value Zₖ of the SNS[k] is stored in the SNS theme statistical value storage 32.

Subsequently, the real theme statistical value predictor 33 corrects the current theme statistical value Zₖ of the SNS[k] using the bias Bₖ in the SNS[k] to thereby calculate the corrected theme statistical value of the SNS[k], and averages the values across all the SNSs to thereby predict the real, current theme statistical value (step 106). Here, the corrected theme statistical value of the SNS[k] may be calculated by, for instance, multiplying the current theme statistical value Zₖ of the SNS[k] by the reciprocal of the bias Bₖ in the SNS[k], that is, by performing calculation of Zₖ/Bₖ. The corrected theme statistical value of the SNS[k] may preferably be averaged by the following expression.

$$( Real , Current Theme Statistical Value ) = {\sum }_{k = 1}^{K} \frac{{Z}_{k}}{{B}_{k}} \qquad Expression 2$$

The method of averaging the corrected theme statistical value of the SNS[k] may be not only such arithmetic mean but also geometrical mean, weighted average according to the number of users, the number of page views in the SNS or the like, for example.

Finally, the information output unit 35 outputs the bias Bₖ in the SNS[k] stored in the bias storage 27 and the real, current theme statistical value stored in the real theme statistical value storage 34 (step 107).

Information stored in each storage of the statistical information analysis apparatus 10 resultantly by such an operation is specifically described.

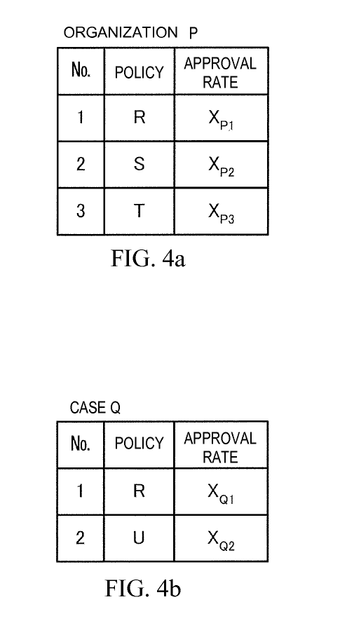

FIGS. 4a and 4b are diagrams showing examples of information stored in the real-related statistical value storage 23.

FIG. 4a shows an example of information on the real-related statistical value X_{Pi} related to the organization P that has been extracted in step 102 and stored in the real-related statistical value storage 23. Here, the approval rate X_{P1} for the policy R proposed by the organization P, the approval rate X_{P2} for the policy S proposed by the organization P, and the approval rate X_{P3} for the policy T proposed by the organization P are shown.

FIG. 4b shows an example of information on the real-related statistical value X_{Qi} related to the case Q that has been extracted in step 102 and stored in the real-related statistical value storage 23. Here, the approval rate X_{Q1} for the policy R related to the case Q, and the approval rate X_{Q2} for the policy U related to the case Q are shown.

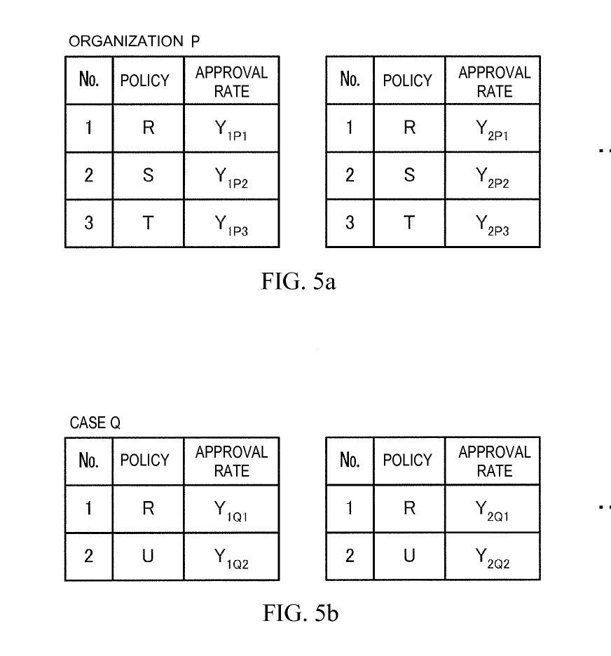

FIGS. 5a and 5b are diagrams showing examples of information stored in the SNS-related statistical value storage 25.

FIG. 5a shows an example of information on the SNS-related statistical value Y_{kPi} related to the organization P that has been extracted in step 103 and stored in the SNS-related statistical value storage 25. Here, on an SNS[1], an approval rate Y1_{P1} for the policy R proposed by the organization P, an approval rate Y1_{P2} for the policy S proposed by the organization P and an approval rate Y1_{P3} for the policy T proposed by the organization P are shown. On an SNS[2], an approval rate Y2_{P1} for the policy R proposed by the organization P, an approval rate Y2_{P2} for the policy S proposed by the organization P and an approval rate Y2_{P3} for the policy T proposed by the organization P are shown.

FIG. 5b shows an example of information on the SNS-related statistical value Y_{kQi} that is related to the case Q and has been extracted in step 103 and stored in the SNS-related statistical value storage 25. Here, on the SNS[1], an approval rate Y1_{Q1} for the policy R related to the case Q and an approval rate Y1_{Q2} for the policy U related to the case Q are shown. On the SNS[2], an approval rate Y2_{Q1} for the policy R related to the case Q and an approval rate Y2_{Q2} for the policy U related to the case Q are shown.

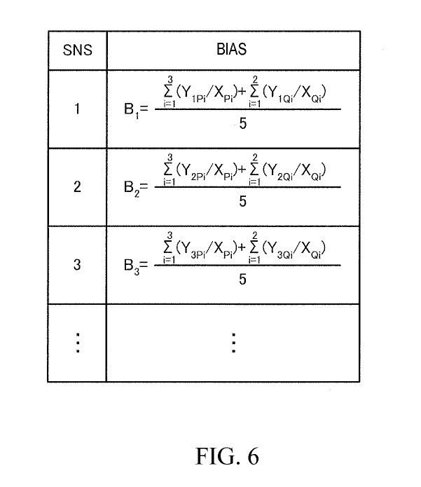

FIG. 6 is a diagram showing an example of information stored in the bias storage 27. This diagram shows that a bias B₁ in the SNS[1], a bias B₂ in the SNS[2] and a bias B₃ in an SNS[3] that have been calculated in step 104 are values acquired by calculation represented in the diagram.

### Second Operation of Statistical Information Analysis Apparatus

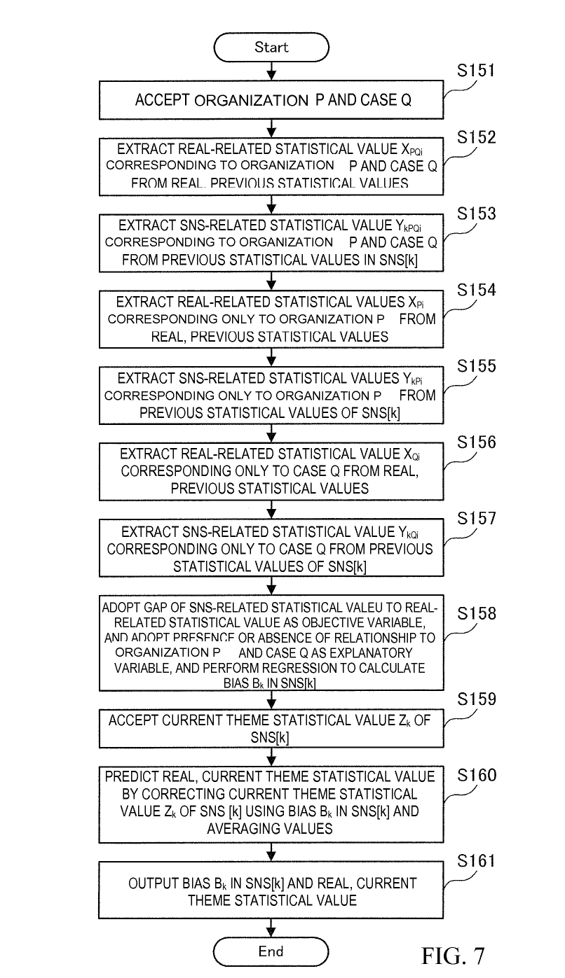

FIG. 7 is a flowchart showing a second operation example of the statistical information analysis apparatus 10. Also in the second operation example, the organization P and the case Q are provided as theme categories.

When the operation is started, the theme category acceptor 21 accepts the organization P and the case Q as theme categories (step 151). These theme categories are passed from the theme category acceptor 21 to the real-related statistical value extractor 22 and the SNS-related statistical value extractor 24.

Next, the real-related statistical value extractor 22 extracts a real-related statistical value X_{PQi} related to both the organization P and the case Q accepted in step 151, from the real, previous statistical values (step 152). For instance, this extractor 22 extracts an approval rate X_{PQ1} for the policy R that is of the organization P and related to the case Q, as the real-related statistical value X_{PQi}. The real-related statistical value X_{PQi} is stored in the real-related statistical value storage 23.

The SNS-related statistical value extractor 24 extracts an SNS-related statistical value Y_{kPQi} that is related to both the organization P and the case Q and has been accepted in step 151, from the previous statistical values of the SNS[k] (step 153). For instance, this extractor 24 extracts an approval rate Y_{kPQ1} for the policy R that is of the organization P and related to the case Q, as the SNS-related statistical value Y_{kPQi}. The SNS-related statistical value Y_{kPQi} is stored in the SNS-related statistical value storage 25.

Next, the real-related statistical value extractor 22 extracts the real-related statistical values X_{Pi} that are related to the organization P accepted in step 151 and are not related to the case Q accepted in step 151, from the real, previous statistical values (step 154). For instance, this extractor 22 extracts the approval rate X_{P1} for the policy S that is of the organization P and is not related to the case Q and the approval rate X_{P2} for the policy T that is of the organization P and is not related to the case Q, as the real-related statistical values X_{Pi}. The real-related statistical values X_{Pi} are stored in the real-related statistical value storage 23.

The SNS-related statistical value extractor 24 extracts the SNS-related statistical values Y_{kPi} that is related to the organization P accepted in step 151 and is not related to the case Q accepted in step 151, from the previous statistical values of the SNS[k] (step 155). For instance, the extractor 24 extracts the approval rate Y_{kP1} for the policy S that is of the organization P and is not related to the case Q and the approval rate Y_{kP2} that is of the organization P and is not related to the case Q, as the SNS-related statistical values Y_{kPi}. The SNS-related statistical value Y_{kPi} is stored in the SNS-related statistical value storage 25.

Next, the real-related statistical value extractor 22 extracts the real-related statistical value X_{Qi} that is not related to the organization P accepted in step 151 and is related to the case Q accepted in step 151, from the real, previous statistical values (step 156). For instance, this extractor 22 extracts the approval rate X_{Q1} for the policy U that is not of the organization P and is related to the case Q, as the real-related statistical value X_{Qi}. The real-related statistical value X_{Qi} is stored in the real-related statistical value storage 23.

The SNS-related statistical value extractor 24 extracts the SNS-related statistical value Y_{kQi} that is not related to the organization P accepted in step 151 and is related to the case Q accepted in step 151, from the previous statistical values of the SNS[k] (step 157). For instance, this extractor 24 extracts the approval rate Y_{kQ1} for the policy U that is not of the organization P and is related to the case Q, as the SNS-related statistical value Y_{kQi}. The SNS-related statistical value Y_{kQi} is stored in the SNS-related statistical value storage 25.

Thus, the real-related statistical values X_{PQi}, X_{Pi} and X_{Qi} are stored in the real-related statistical value storage 23, and the SNS-related statistical values Y_{kPQi}, Y_{kPi} and Y_{kQi} are stored in the SNS-related statistical value storage 25, and then the bias calculator 26 calculates the bias Bₖ in the SNS[k] on the basis of the real-related statistical values X_{PQi}, X_{Pi} and X_{Qi} and the SNS-related statistical values Y_{kPQi}, Y_{kPi} and Y_{kQi}. That is, a relative value of the SNS-related statistical value to the real-related statistical value on a certain statistical theme is adopted as an objective variable, and a vector in which an element corresponding to a theme category to which the statistical theme belongs is “1” and an element corresponding to a theme category to which the statistical theme does not belong is “0” is adopted as an explanatory variable, and regression is performed to calculate the bias Bₖ (step 158). Here, the relative value of the SNS-related statistical value to the real-related statistical value is the gap (deviation) between the SNS-related statistical value and the real-related statistical value, and may be the difference between the SNS-related statistical value and the real-related statistical value, the ratio of the SNS-related statistical value to the real-related statistical value, the difference that is between the SNS-related statistical value and the real-related statistical value and normalized by the real-related statistical value, or the like. In the case of regression, the elements u and v of the explanatory variable (u, v) are regarded as variables representing presence or absence of relationship to the organization P and representing presence or absence of relationship to the case Q, respectively, and the objective variable for each explanatory variable is defined as (Yₖ−X)/X. That is, for the explanatory variable (1, 1), the objective variable is defined as (Y_{kPQi}−X_{PQi})/X_{PQi}. For the explanatory variable (1, 0), the objective variable is defined as (Y_{kPi}−X_{Pi})/X_{Pi}. For the explanatory variable (0, 1), the objective variable is defined as (Y_{kQi}−X_{Qi})/X_{Qi}. As a result of regression, the following regression expression is acquired, and the (aₖ, bₖ) is adopted as the bias Bₖ in the SNS[k].

$$\frac{{Y}_{k} - X}{X} = {a}_{k} \times u + {b}_{k} \times v \qquad Expression 3$$

Here, the bias Bₖ in the SNS[k] includes information on how the statistical theme related to the theme category is likely to be supported in the SNS[k].

In a variation thereof, the relationship between the statistical theme and the theme category may be provided not only as “0” and “1”, but also as a continuous value indicating an index (polarity) representing no relationship, an index (relationship degree) representing a degree of relationship or the like.

Meanwhile, the SNS theme statistical value acceptor 31 accepts the current theme statistical value Zₖ of the SNS[k] (step 159). The current theme statistical value Zₖ of the SNS[k] is stored in the SNS theme statistical value storage 32.

Subsequently, the real theme statistical value predictor 33 corrects the current theme statistical value Zₖ of the SNS[k] using the bias Bₖ in the SNS[k] to calculate the corrected theme statistical value of the SNS[k], and averages the values across all the SNSs to thereby predict the real, current theme statistical value (step 160). Here, the corrected theme statistical value of the SNS[k] may be calculated, for instance, by substituting the current theme statistical value Zₖ of the SNS[k] for Yₖ of the above-described regression expression and solving the expression for X. That is, in the case of using the regression expression, it is preferred to perform calculation by the following expression.

$$X = \frac{{Z}_{k}}{{a}_{k} \times u + {b}_{k} \times v + 1} \qquad Expression 4$$

The method of averaging the corrected theme statistical value of the SNS[k] may be arithmetic mean, geometrical mean, weighted average using the number of users, the number of page views in the SNS or the like, for example.

Finally, the information output unit 35 outputs the bias Bₖ in the SNS[k] stored in the bias storage 27, and the real, current theme statistical value stored in the real theme statistical value storage 34 (step 161).

Information stored in each storage of the statistical information analysis apparatus 10 resultantly by such an operation is specifically described.

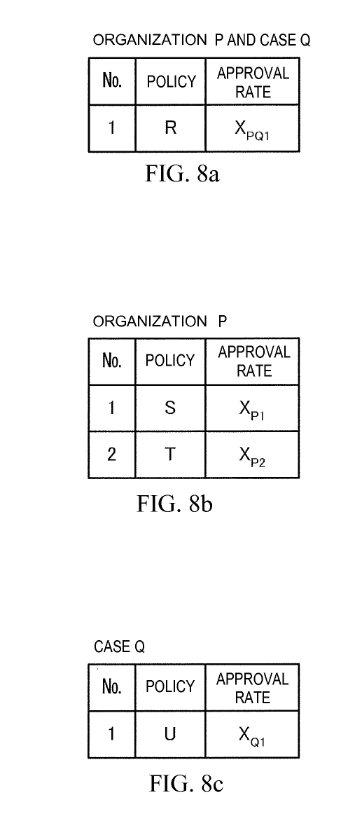

FIGS. 8a to 8c are diagrams showing examples of information stored in the real-related statistical value storage 23.

FIG. 8a is an example of information on the real-related statistical value X_{PQi} that is related to both the organization P and the case Q and has been extracted in step 152 and stored in the real-related statistical value storage 23. Here, the approval rate X_{PQ1} for the policy R that is related to the case Q and proposed by the organization P.

FIG. 8b is an example of information on the real-related statistical value X_{Pi} that has been extracted in step 154 and stored in the real-related statistical value storage 23 and is related to the organization P and is not related to the case Q. Here, the approval rate X_{P1} for the policy S that is proposed by the organization P and is not related to the case Q, and the approval rate X_{P2} for the policy T that is proposed by the organization P and is not related to the case Q are shown.

FIG. 8c is an example of information on the real-related statistical value X_{Qi} that has been extracted in step 156 and stored in the real-related statistical value storage 23 and is not related to the organization P and is related to the case Q. Here, the approval rate X_{Q1} for the policy U that is not proposed by the organization P and is related to the case Q is shown.

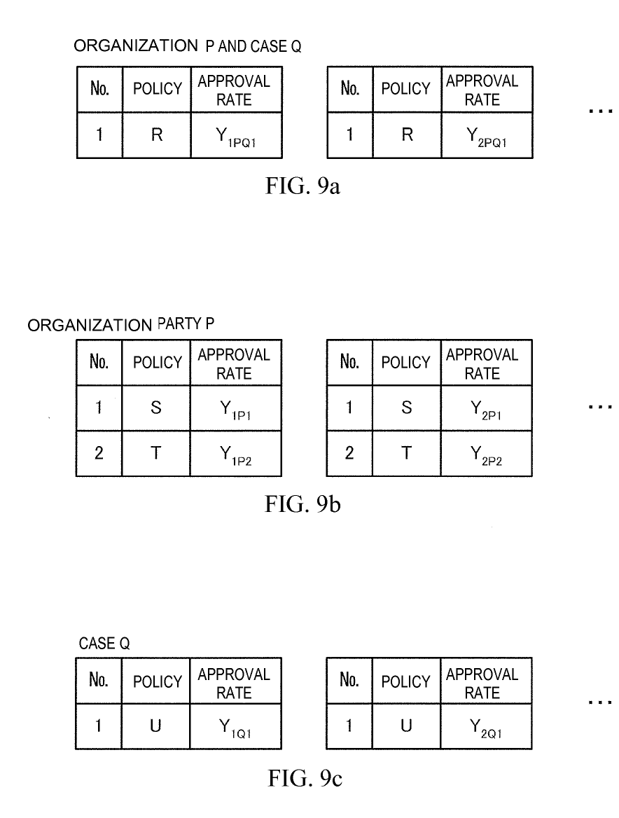

FIGS. 9a to 9c are diagrams showing examples on information stored in the SNS-related statistical value storage 25.

FIG. 9a shows an example of information on the SNS-related statistical value Y_{kPQi} that has been extracted in step 153 and stored in the SNS-related statistical value storage 25 and is related to both the organization P and the case Q. Here, the approval rate Y_{kPQ1} for the policy R proposed by the organization P and related to the case Q is shown.

FIG. 9b shows an example of information on the SNS-related statistical value Y_{kPi} that has been extracted in step 155 and stored in the SNS-related statistical value storage 25 and is related to the organization P and is not related to the case Q. Here, the approval rate Y_{kP1} for the policy S that is proposed by the organization P and is not related to the case Q, and the approval rate Y_{kP2} for the policy T that is proposed by the organization P and is not related to the case Q are shown.

FIG. 9c shows an example of information on the SNS-related statistical value Y_{kQi} that has been extracted in step 157 and stored in the SNS-related statistical value storage 25 and is not related to the organization P and is related to the case Q. Here, the approval rate Y_{kQ1} for the policy U that is not proposed by the organization P and is related to the case Q is shown.

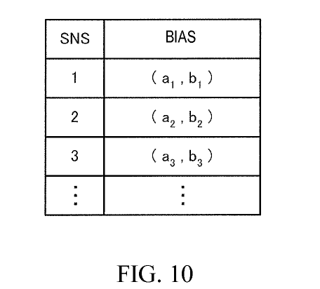

FIG. 10 is a diagram showing an example of information stored in the bias storage 27. Here, it is shown that the bias B₁ in the SNS[1], and the bias B₂ in the SNS[2] and the bias B₃ in the SNS[3] that have been calculated in step 158 are provided as regression coefficients as shown in the diagram.

As described above, in this embodiment, the real-related statistical value corresponding to the theme category is extracted from the real, previous statistical values, the SNS-related statistical value corresponding to the theme category is extracted from the previous statistical values of the SNS, and the bias in the SNS is calculated on the basis of the gap between the real-related statistical value and the SNS-related statistical value. Accordingly, the bias in the information on the SNS can be grasped and then the survey based on the information can be performed.

Thus, in this embodiment, the bias is used for the survey based on the information on the SNS. However, the present invention is not limited thereto. The bias may be used to grasp variation in an SNS (e.g., conservative swing etc.).

Here, the present invention may be implemented entirely using hardware, or entirely using software. Alternatively, the present invention can be implemented using both hardware and software. The present invention may be achieved as a computer, a data processing system, or a computer program. The computer program may be stored in a computer-readable medium and provided. Here, the medium may be an electronic, magnetic, optical, electromagnetic, infra-red or semiconductor system (apparatus or equipment), or a propagation medium. The computer-readable medium is exemplified as a semiconductor or solid state memory device, a magnetic tape, a removable computer diskette, a random access memory (RAM), a read-only memory (ROM), a rigid magnetic disk, and an optical disk. Examples of optical disks at this point of time include a compact disc read-only memory (CD-ROM), a compact disc read/write (CD-R/W) and a DVD.

The present invention has thus been described using the embodiment. However, the technical scope of the present invention is not limited to the embodiment. It is apparent for those skilled in the art that various changes can be made and alternative modes can be adopted without departing from the spirit and scope of the present invention.

In order to achieve such an object, the present invention provides an apparatus for supporting a survey based on information in an Internet medium, including: a first acquisition unit of acquiring first evaluation information representing a degree of evaluation acquired by the survey in a real society pertaining to a prescribed target; a second acquisition unit of acquiring second evaluation information representing a degree of evaluation in the Internet medium pertaining to the prescribed target; and an estimator estimating a bias in information in the Internet medium on the basis of a deviation of the second evaluation information from the first evaluation information.

Here, the first acquisition unit may acquire the first evaluation information representing the degree of evaluation acquired by the survey in the real society pertaining to the prescribed target belonging to a prescribed category, the second acquisition unit may acquire the second evaluation information representing the degree of evaluation in the Internet medium pertaining to the prescribed target belonging to the prescribed category, and the estimator may estimate the bias in the information in the Internet medium to the prescribed category on the basis of the deviation of the second evaluation information from the first evaluation information.

Furthermore, the first acquisition unit may acquire, for each target among a plurality of targets, the first evaluation information representing the degree of evaluation acquired by the survey in the real society pertaining to each of the targets; the second acquisition unit may acquire, for each target among the plurality of targets, the second evaluation information representing the degree of evaluation in the Internet medium pertaining to each of the targets; and the estimator may estimate the bias in the information in the Internet medium by averaging, across the targets, the deviation of the second evaluation information from the first evaluation information on each target among the targets.

Meanwhile, the first acquisition unit may acquire, for each target among a plurality of targets belonging to any of a plurality of categories, the first evaluation information representing the degree of evaluation acquired by the survey in the real society pertaining to each of the targets, the second acquisition unit may acquire, for each target among the plurality of targets, the second evaluation information representing the degree of evaluation in the Internet medium pertaining to each of the targets, and the estimator may estimate the bias in the information in the Internet medium by performing regression while adopting, as an objective variable, information representing the deviation of the second evaluation information from the first evaluation information on each target among the targets, and adopting, as an explanatory variable, information representing whether each of the targets belongs to each of the categories or not.

This apparatus may further include: a third acquisition unit of acquiring third evaluation information representing a degree of evaluation in the Internet medium pertaining to another target related to the prescribed target; and a predictor predicting actual evaluation pertaining to the other target on the basis of the bias and the third evaluation information.

The present invention also provides an apparatus for supporting a survey based on information in an Internet medium, including: a first acquisition unit of acquiring, for each policy among a plurality of policies belonging to any of a plurality of categories predefined according to a policy of a target of the survey, a first evaluation value representing a degree of affirmative evaluation acquired by a survey in a real society pertaining to each of the policies; a second acquisition unit of acquiring, for each policy among the plurality of policies, a second evaluation value representing a degree of affirmative evaluation in the Internet medium pertaining to each of the policies; an estimator estimating a bias in information in the Internet medium by averaging, across the policies, a degree of a deviation of the second evaluation value from the first evaluation value on each policy among the policies; a third acquisition unit of acquiring a third evaluation value representing a degree of affirmative evaluation in the Internet medium pertaining to the policy of the target of the survey; and a predictor predicting a degree of actual affirmative evaluation pertaining to the policy of the target of the survey by correcting the third evaluation value on the basis of the bias.

Meanwhile, the present invention also provides an apparatus for supporting a survey based on information in an Internet medium, including: a first acquisition unit of acquiring, for each policy among a plurality of policies belonging to any of a plurality of categories predefined according to a policy of a target of the survey, a first evaluation value representing a degree of affirmative evaluation acquired by a survey in a real society pertaining to each of the policies; a second acquisition unit of acquiring, for each policy among the plurality of policies, a second evaluation value representing a degree of affirmative evaluation in the Internet medium pertaining to each of the policies; an estimator estimating a regression expression having, as a regression coefficient, a bias in information in the Internet medium, by performing regression while adopting, as an objective variable, a degree of a deviation of the second evaluation value from the first evaluation value on each policy among the policies and adopting, as an explanatory variable, information representing whether each policy belongs to each of the categories or not; a third acquisition unit of acquiring a third evaluation value representing a degree of affirmative evaluation in the Internet medium pertaining to the policy of the target of the survey; and a predictor predicting a degree of actual affirmative evaluation pertaining to the policy of the target of the survey by setting the third evaluation value as the second evaluation value in the objective variable of the regression expression.

The present invention further provides a method for supporting a survey based on information in an Internet medium, including: a step of acquiring first evaluation information representing a degree of evaluation acquired by a survey in a real society pertaining to a prescribed target; a step of acquiring second evaluation information representing a degree of evaluation in the Internet medium pertaining to the prescribed target; and a step of estimating a bias in information in the Internet medium on the basis of a deviation of the second evaluation information from the first evaluation information.

The present invention further provides a program causing a computer to function as an apparatus for supporting a survey based on an Internet medium, the program causing the computer to function as: a first acquisition unit of acquiring first evaluation information representing a degree of evaluation acquired by a survey in a real society pertaining to a prescribed target; a second acquisition unit of acquiring second evaluation information representing a degree of evaluation in the Internet medium pertaining to the prescribed target; and an estimator estimating a bias in information in the Internet medium on the basis of a deviation of the second evaluation information from the first evaluation information.

The present invention can grasp a bias in information in an Internet medium and then perform a survey on the basis of the information.

A bias in information in an Internet medium can be grasped to allow a survey based on the information.

In a statistical information analysis apparatus 10, a theme category acceptor 21 accepts a category of a statistical theme. A real-related statistical value extractor 22 extracts a real-related statistical value related to the category from real, previous statistical values. An SNS-related statistical value extractor 24 extracts an SNS-related statistical value related to the category from previous SNS statistical values. A bias calculator 26 calculates a bias in an SNS on the basis of a gap between the real-related statistical value and the SNS-related statistical value. An SNS theme statistical value acceptor 31 accepts a current theme statistical value of the SNS. A real theme statistical value predictor 33 corrects the value using the bias in the SNS to predict a real, current theme statistical value. An information output unit 35 outputs the bias in the SNS and the real, current theme statistical value.

What is claimed is:

1. An apparatus for supporting a survey based on information in an Internet medium, the apparatus comprising:
a first acquisition hardware unit, wherein the first acquisition hardware unit acquires first evaluation information representing a degree of evaluation acquired by a survey of a real society pertaining to a prescribed target;
a second acquisition hardware unit, wherein the second acquisition hardware unit acquires second evaluation information representing a degree of evaluation in the Internet medium pertaining to the prescribed target; and
an estimator hardware unit, wherein the estimator hardware unit estimates a bias in information in the Internet medium based on a deviation of the second evaluation information from the first evaluation information.

2. The apparatus according to claim 1,
wherein the first acquisition hardware unit acquires the first evaluation information representing the degree of evaluation acquired by the survey in the real society pertaining to the prescribed target belonging to a prescribed category,
the second acquisition hardware unit acquires the second evaluation information representing the degree of evaluation in the Internet medium pertaining to the prescribed target belonging to the prescribed category, and
the estimator hardware unit estimates the bias in the information in the Internet medium to the prescribed category based on the deviation of the second evaluation information from the first evaluation information.

3. The apparatus according to claim 1,
wherein the first acquisition hardware unit acquires, for each target among a plurality of targets, the first evaluation information representing the degree of evaluation acquired by the survey in the real society pertaining to each of the plurality of targets,
the second acquisition hardware unit acquires, for each target among the plurality of targets, the second evaluation information representing the degree of evaluation in the Internet medium pertaining to each of the plurality of targets, and
the estimator hardware unit estimates the bias in the information in the Internet medium by averaging, across the plurality of targets, the deviation of the second evaluation information from the first evaluation information on each target among the plurality of targets.

4. The apparatus according to claim 1,
wherein the first acquisition hardware unit acquires, for each target among a plurality of targets belonging to any of a plurality of categories, the first evaluation information representing the degree of evaluation acquired by the survey in the real society pertaining to each of the targets,
the second acquisition hardware unit acquires, for each target among the plurality of targets belonging to any of the plurality of categories, the second evaluation information representing the degree of evaluation in the Internet medium pertaining to each of the targets, and
the estimator hardware unit estimates the bias in the information in the Internet medium by performing regression while adopting, as an objective variable, information representing the deviation of the second evaluation information from the first evaluation information on each target among the targets, and adopting, as an explanatory variable, information representing whether each of the targets belongs to each category of the plurality of categories.

5. The apparatus according to claim 1, further comprising:
a third acquisition hardware unit, wherein the third acquisition hardware unit acquires third evaluation information representing a degree of evaluation in the Internet medium pertaining to another target related to the prescribed target; and
a predictor hardware unit, wherein the predictor hardware unit predicts an actual evaluation pertaining to said another target based on the bias and the third evaluation information.

6. An apparatus for supporting a survey based on information in an Internet medium, the apparatus comprising:
a first acquisition hardware unit, wherein the first acquisition hardware unit acquires, for each policy among a plurality of policies belonging to any of a plurality of categories predefined according to a policy of a target of the survey, a first evaluation value representing a degree of affirmative evaluation acquired by a survey in a real society pertaining to each policy among the plurality of policies;
a second acquisition hardware unit, wherein the second acquisition hardware unit acquires, for each policy among the plurality of policies, a second evaluation value representing a degree of affirmative evaluation in the Internet medium pertaining to each policy among the plurality of policies;
an estimator hardware unit, wherein the estimator hardware unit estimates a bias in information in the Internet medium by averaging, across the plurality of policies, a degree of a deviation of the second evaluation value from the first evaluation value on each policy among the plurality of policies;
a third acquisition hardware unit, wherein the third acquisition hardware unit acquires a third evaluation value representing a degree of affirmative evaluation in the Internet medium pertaining to the policy of the target of the survey; and
a predictor hardware unit, wherein the predictor hardware unit predicts a degree of actual affirmative evaluation pertaining to the policy of the target of the survey by correcting the third evaluation value based on the bias.

7. An apparatus for supporting a survey based on information in an Internet medium, the apparatus comprising:
a first acquisition hardware unit, wherein the first acquisition hardware unit acquires, for each policy among a plurality of policies belonging to any of a plurality of categories predefined according to a policy of a target of the survey, a first evaluation value representing a degree of affirmative evaluation acquired by a survey in a real society pertaining to each policy among the plurality of policies;
a second acquisition hardware unit, wherein the second acquisition hardware unit acquires, for each policy among the plurality of policies, a second evaluation value representing a degree of affirmative evaluation in the Internet medium pertaining to each policy among the plurality of policies;
an estimator hardware unit, wherein the estimator hardware unit estimates a regression expression having, as a regression coefficient, a bias in information in the Internet medium, by performing regression while adopting, as an objective variable, a degree of a deviation of the second evaluation value from the first evaluation value on each policy among the plurality policies and adopting, as an explanatory variable, information representing whether each policy among the plurality of policies belongs to each category of the plurality of categories;
a third acquisition hardware unit, wherein the third acquisition hardware unit acquires a third evaluation value representing a degree of affirmative evaluation in the Internet medium pertaining to the policy of the target of the survey; and
a predictor hardware unit, wherein the predictor hardware unit predicts a degree of actual affirmative evaluation pertaining to the policy of the target of the survey by setting the third evaluation value as the second evaluation value in the objective variable of the regression expression.
